(19) United States
(12) Patent Application Publication
(10) Pub. No.: US 2003/0137636 A1
(43) Pub. Date: Jul. 24, 2003

(54) Edge protection ring for polishing a lens

(76) Inventor: Kok-Ming Tai, Lawrenceville, GA (US)

Correspondence Address: THOMAS HOXIE, NOVARTIS, CORPORATE INTELLECTUAL PROPERTY, ONE HEALTH PLAZA 430/2, EAST HANOVER, NJ, 07936-1080, US

(21) Appl. No.: 10/338,256

(22) Filed: Jan. 8, 2003

Related U.S. Application Data
(60) Provisional application No. 60/349,527, filed on Jan. 18, 2002.

(51) Int. Cl. G02C 7/02

(52) U.S. Cl. 351/177

(57) ABSTRACT

Covering an ophthalmic lens edge but leaving optical surfaces of the lens exposed, inserting the lens into a container with a fluid, and agitating the container to polish the lens optic surfaces but not the lens edge. The lens edge can be covered by providing an annular member having an inner surface and a slot defined in the inner surface that is configured to receive and protect the lens edge.

### STATEMENT OF RELATED APPLICATION

This application claims the benefit under 35 U.S.C.§ 119 (e) of U.S. provisional application serial No. 60/349,527 filed Jan. 18, 2002.

### TECHNICAL FIELD

This invention relates generally to articles and methods for manufacturing lenses and, more particularly, to polishing intraocular memory lenses while protecting their edges.

### BACKGROUND OF THE INVENTION

When patients have cataract surgery involving removal of their natural eye lenses, conventional surgical procedures include implanting intraocular lenses (IOL's) to replace the removed lenses. A known type of IOL is the memory lens, which can be folded or otherwise deformed into a compact space, implanted into the patient's eye through a small slit cut into the eye, and then returned to its original shape.

Memory IOL's are often made with square edges. This is because rounded edges provide a generally wedge-shaped opening that can allow cells and/or other particles to migrate behind the lens. When cells migrate behind the lens they can cause posterior chamber opacification (PCO), which results in clouding and impaired vision.

Known methods of manufacturing IOL's involve molding or lathe-cutting them with square edges and then polishing them to remove any surface irregularities resulting from the molding or lathing process. The polishing process typically involves agitating a container holding the lenses and a polishing slurry such as a fluid and polishing beads to provide a tumble-polishing effect. Unfortunately, during the polishing step the square edges of the lenses are also subjected to the polishing effect, thereby rounding off the square edges. The IOL's so produced then subject their users to the likelihood of impaired vision from PCO.

Accordingly, a need remains in the art for a method of polishing ophthalmic lenses that eliminates or reduces the polishing effect at or adjacent the edge of the lens. Also, there is a need for such a method that does not degrade the effectiveness of the desired polishing effect on the optic surfaces of the lens. Additionally, there is a need for an article that can be used to prevent rounding off square edges during the lens polishing process. It is to the provision of such a method and article that the present invention is primarily directed.

### SUMMARY OF THE INVENTION

Briefly described, the present invention provides for polishing the optical surfaces of an introcular or other ophthalmic lens while protecting the edge of the lens. By protecting the square edge of the lens, it is maintained generally intact instead of being rounded off. Thus, the end users of the lens are less likely to be subjected to loss of vision from PCO.

An exemplary embodiment of the present invention includes a protection ring that is used in the polishing step of the lens manufacturing process. The protection ring is preferably an annular member having an inner surface and a slot defined in the inner surface. The slot is configured to receive and protect the lens edge, but not the lens optical surfaces. Because the lens edge is so protected, the lens optical surfaces can be polished without rounding off or otherwise altering the shape of the lens edge.

An exemplary lens polishing method of the present invention includes covering the lens edge but leaving its optic surfaces exposed, inserting the lens into a container with a fluid, agitating the container, removing the lens from the container, and uncovering the lens edge. The lens edge can be covered by using the protection ring or by covering the lens edge with another edge-protector. When the container is agitated with a number of the edge-protected lenses in it, the optical surfaces of each lens are tumble-polished. But the edge of each lens is covered and protected from the polishing effect.

Another example method of the present invention provides for inserting and removing the lens from the ring using tools with fingers that can be inserted into and retracted from grooves in the sides of the ring. The tools can be used to stretch the ring to enlarge the size of the opening in the ring to receive the lens. The tools can be used manually or they can be automatically controlled to perform this operation.

Additionally, an exemplary lens manufacturing method of the present invention includes molding or otherwise forming the lens, polishing the lens, and packaging the lens for sterility during shipping and storage. The polishing step is preferably performed by the lens polishing method described herein.

Accordingly, the present invention provides a protection ring and polishing and manufacturing methods for covering the edge of a lens during the polishing process. The lens optical surfaces, however, are left exposed for the desired polishing. In this way, the lens optical surfaces are polished to remove any irregularities, but the lens edge is not polished. Thus, the desired shape of the lens edge is maintained during the polishing process, and the lens will provide the desired fit in the wearer's eye.

### BRIEF DESCRIPTION OF THE DRAWING FIGURES

FIG. 1 is a plan view of a protection ring of an exemplary embodiment of the present invention.

FIG. 2 is a cross-sectional view of the ring taken at line 2-2 of FIG. 1, showing the ring in use with an intraocular lens with the lens edge protected by the ring and the lens optical surfaces left exposed for polishing.

FIG. 3 is a flow diagram of an exemplary lens polishing method of the present invention.

FIG. 4 is a cross-sectional view of a polishing container for use in the method of FIG. 3, showing the container holding a polishing slurry and a load of the edge-protected lenses.

FIG. 5 is an end view of the container of FIG. 4, showing the container being rotated by rollers to tumble-polish the lenses.

FIG. 6 is a cross-sectional view of the ring of FIG. 1 in use according to an alternative method of the present invention, showing tool fingers engaging grooves in the ring for deforming the ring to permit insertion and removal of the lens.

FIG. 7 is a plan view of the ring of FIG. 6, showing the motion of the tool fingers to deform the ring.

### DETAILED DESCRIPTION OF THE EXEMPLARY EMBODIMENTS

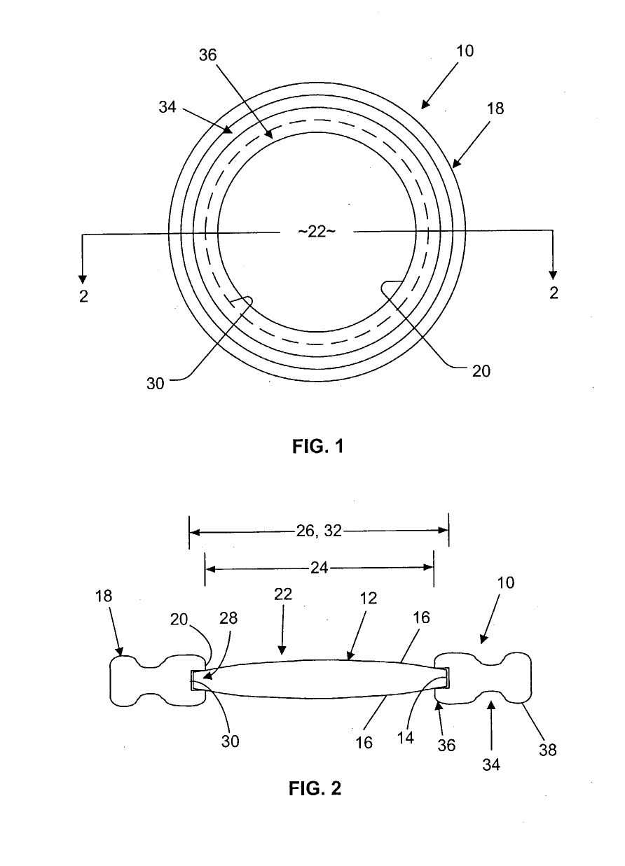

Referring now to the drawing figures, wherein like reference numerals represent like parts throughout the several views, FIGS. 1 and 2 show a protection ring of an exemplary embodiment of the present invention, generally referred to as the ring 10. The ring 10 can be used when polishing a lens 12 such as an intraocular lens having a square edge 14 and two curved optical power surfaces 16. The unique features of the ring 10 permit polishing of the lens optic surfaces 16 while protecting the lens edge 14. In this way, the optic surfaces 16 can be polished to remove any surface irregularities without altering the lens edge 14.

The ring 10 is preferably an annular member 18 having an inner surface 20 forming an opening 22 with a diameter 24 that is smaller than the lens diameter 26. The inner surface 20 has a slot 28 in it that is formed with a shape and size to receive the lens edge 14. To receive the lens edge 14 with a secure but releasable fit, the slot 28 preferably has a bottom surface 30 with a diameter 32 that is about the same as the lens diameter 26. Also, the shape of the slot 28 is preferably selected to generally conform to the shape of the lens edge 14. Of course, the bottom surface diameter 32 can be slightly larger or smaller than the lens diameter 26, and the shape of the slot 28 can be different from that of the lens edge 14, as long as the lens edge can be held and protected within the slot. So configured, the lens 12 can be inserted into the opening 22 with the lens edge 14 held and protected within the slot 28 while the lens optic surfaces 16 are exposed for polishing.

The annular member 18 is preferably made of an elastic material such as an EPDM material. In this way, the ring 10 can be stretched, bent, twisted, or otherwise deformed to enlarge and contract the opening 22 or portions thereof to insert and remove the lens 12 from the ring 10. Also, the annular member 18 is preferably molded or otherwise fabricated in a one-piece construction. This provides for simple and efficient manufacturing and use of the ring 10.

Alternatively, the annular member 18 can be made of a rigid material and/or formed in a two-piece construction with a base and a collar that mates with the base to form a slot for receiving the lens edge. In another alternative form, the annular member can be provided in a two-piece construction with an inner portion adjacent the inner surface that is made of an elastic material and with an outer portion that is made of a rigid material.

In a further preferred and optional embodiment, the annular member 18 comprises one or more grooves 34 in its sides. The grooves 34 are preferably sized and shaped to receive fingers of one or more tools for grasping and deforming the annular member 18 to permit insertion and removal of the lens 12 (see also FIGS. 6 and 7). Also, the vacant space provided by the grooves 34 facilitate an easy pivotal movement and deformation of the flanges 36 bounding the slot 28 when inserting and removing the lens edge 14. Additionally or alternatively, the annular member 18 can have an outer head 38 that comprises one or more gripping surfaces adapted for grasping either manually or by a tool to similarly deform it.

The ring 10 of the present invention can be used with intraocular lenses made of an optical-grade biocompatible material such as a silicone, acrylic, or other material. Also, the ring 10 can be used with lenses having a rounded or otherwise-shaped edge, lenses having one square and one rounded edge, lenses having various forms and combinations of optic surfaces, soft contact lenses, hard contact lenses, and other ophthalmic lenses, or other optic lenses. Furthermore, the ring 10 can be configured for use with lenses having spheric, aspheric, toric, rectangular, polygonal, or otherwise-shaped optic surfaces by selecting the shape of the inner surface and opening to generally conform to the shape of the lens surface.

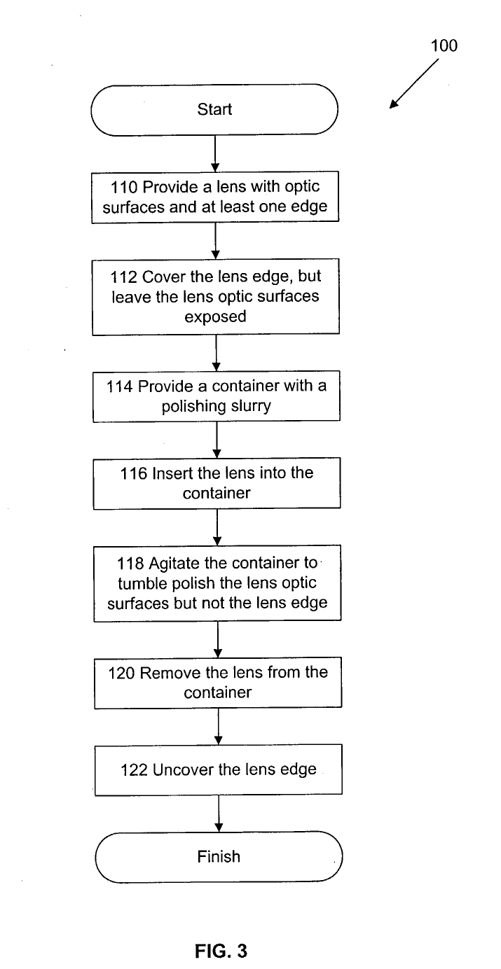

Turning now to FIG. 3, there is depicted a flow diagram of an exemplary lens polishing method of the present invention, referred to generally as the polishing method 100. The polishing method 100 provides for polishing the optic surfaces of the lens without polishing or otherwise altering the edges of the lens.

The polishing method 100 preferably includes at 110 providing a lens to be polished. The lens can be provided by, for example, an intraocular or other ophthalmic lens such as that described above, or another lens, as may be desired. Such a lens can be made by lathe-cutting, molding or otherwise.

At step 112 the polishing method 100 includes covering the lens edge but leaving the lens optic surfaces exposed. For example, the lens edge can be covered using the ring described herein. Accordingly, the lens edge is preferably covered by inserting it into the ring slot while leaving the lens optic surfaces exposed through the opening. This can be done manually by positioning the lens is and the ring adjacent to each other and then pressing them together. The flange bounding the slot will deform inwardly to permit the lens edge to slip into the slot, then the flange will elastically return to its prior position. Alternatively, the lens edge can be covered using a removable adherent such as a tape, gel, film, or epoxy, using a two-piece base and collar protector, or using another cover that protects the lens edge while leaving the lens optic surfaces exposed.

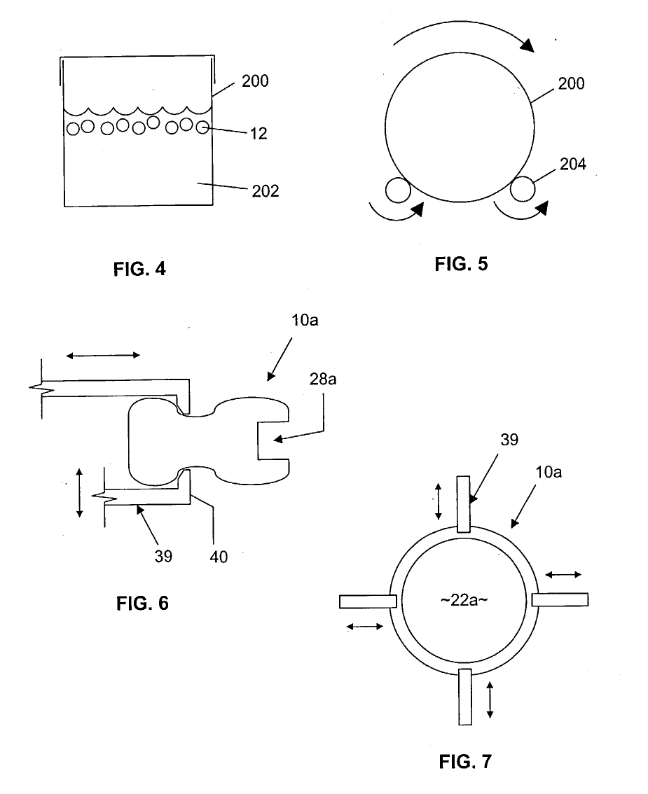

Then at step 114 the polishing method 100 includes providing a container holding a fluid or other polishing media. For example as shown in FIG. 4, a container 200 such as cylindrical jar can be provided, preferably having a diameter of about 4 or 5 inches. The fluid is preferably a polishing slurry 202 including a solvent such as water, alcohol, and/or sodium hydroxide, polishing beads made of glass or another material, and/or other compositions and articles selected for providing a mildly abrasive effect sufficient to tumble-polish the lenses

Once the lens edges are covered, then at step 116 the edge-covered lenses are inserted into the container. For example, about 30-80 lenses can be polished at once. Alternatively, only one or another number of lenses can be polished at a time, as may be desired in a given situation, and as accommodated by the container used.

Next, at step 118 the container 200 is agitated to create a tumble-polishing effect. For example, as shown in FIG. 5, the container can be agitated by positioning and rotating it on one or more rollers 204. The rollers 204 are preferably operatively coupled to one or more motors or other actuators with controllers that are configured to agitate the container for a period of time and at a speed sufficient to remove any remaining undesired surface irregularities on the lens optical surfaces. Alternatively, the container is agitated using a reciprocating motion, a combined rotary and reciprocating motion, or by otherwise agitating it. In any event, because the lens edge is protected, it is not subjected to the tumble-polishing effect, and its geometry remains unaffected.

Then at step 120, the lenses are removed from the container, either manually or by an automated process. Next, at step 122, for each lens, its edge is uncovered from the ring or other protector. Where the ring 10 of the present invention is used, this can be accomplished by bending the ring to expose a portion of the lens edge and then grasping that or another portion of the lens. The lens edge can then be removed from the corresponding slot and the lens optic surfaces removed from the opening. At this point, the lenses just polished are optionally inspected to confirm that the desired surface quality has been achieved on the lens optic surfaces, and any necessary additional polishing can be accomplished by repeating the polishing method 100.

Referring now to FIGS. 6 and 7, in an alternative form, the polishing method comprises an automated process for inserting and removing the lens from the ring 10a. The grooves 34 of the ring 10a are preferably engaged and moved outwardly (by pulling, pushing, or otherwise) at one or more positions to enlarge the ring opening 22a. For example, a number of tools 39 can be provided, each with fingers 40 that are adapted for engagement with the grooves 34 of the ring. The position of the fingers 40 preferably can be adjusted for insertion into and removal from the grooves 34, and the position of the tools 39 preferably can be adjusted for enlarging the opening 22a when the fingers 40 are engaged in the grooves. Such repositioning of the tools 39 and fingers 40 can be selectively achieved, for example, by a controller programmed to operate one or more actuators coupled to the tools.

Once the ring opening 22a is expanded to a pre-selected size, the lens is preferably inserted into the opening with the lens edge 14 extending into the slot 28a. This can be carried out manually, or in an automated process by repositioning the tools 39 (and thus the ring) or by repositioning a lens support member holding the lens. Next the controller operates the actuator to return the tools 39 to their prior position and to retract the fingers 40 from the grooves 34. The ring 10a is thereby released to elastically contract the size of the opening 22a to hold the lens in place. At this point, the edge-protected lens can be polished, for example, according to the lens polishing method described above.

After polishing the lens, it is removed from the ring 10a by again expanding is the opening 22a, removing the lens manually or supporting it on the lens support member, and releasing the ring, in a manner similar to the process just described for inserting the lens in the ring. If another lens is to be inserted into the ring for polishing, the next lens can be inserted into the ring while its opening remains expanded from the removal of the just-polished lens.

In an alternate form, the invention includes a method of manufacturing an ophthalmic or other lens. In preferred form, the manufacturing method includes molding, lathe-cutting or otherwise forming a lens with optic surfaces and at least one edge, polishing the lens in a manner similar to the method described above, and packaging the lens in a lens receptacle.

Accordingly, the present invention provides a protection ring and polishing and manufacturing methods that provide for covering and protecting the edge of an ophthalmic lens during the polishing process while leaving the lens optic power surfaces exposed for the desired polishing. In this way, the lens optical surfaces can be polished to remove any irregularities, but the lens edge is not polished and the desired shape of the lens edge is maintained. Lenses polished in this way will better provide the desired fit in the wearer's eye and preferably will eliminate or significantly reduce the incidence of vision-impairing conditions including PCO.

In the embodiments described above and the following claims, the use of a singular or plural form of a term is not intended to limit the term to that form. For example, the words “a,” “an,” and “one” are not intended to mean “only one” but can also mean “more than one.” Also, the method steps described herein are not intended to be limited to the specific sequences described but can be carried out in other sequences. Furthermore, while the invention has been disclosed in exemplary forms, those skilled in the art will recognize that many modifications, additions, and deletions can be made therein without departing from the spirit and scope of the invention as set forth in the following claims.

What is claimed is:

1. A method of polishing a lens having at least one optic surface and at least one edge, the method comprising:
a) covering the lens edge but leaving the at least one lens optic surface exposed;
b) inserting the lens into a container containing a fluid;
c) agitating the container, wherein the at least one lens optic surface is polished but the lens edge is not polished;
d) removing the lens from the container; and
e) uncovering the lens edge.

2. The method of claim 1, further comprising providing an annular member having an inner surface forming an opening and a slot defined in the inner surface, wherein the step of covering the lens edge includes inserting the lens edge into the annular member slot, and the step of uncovering the lens edge comprises removing the lens edge from the slot.

3. The method of claim 2, wherein the step of inserting the lens edge into the slot comprises pressing the lens and the annular member together.

4. The method of claim 2, wherein the step of removing the lens edge comprises bending the annular member to expose a portion of the lens edge.

5. The method of claim 2, wherein the step of inserting the lens edge into the slot comprises engaging and moving outwardly a plurality of portions of the annular member to expand the opening, inserting the lens edge into the slot, and releasing the annular member to permit the opening to elastically contract; and wherein the step of removing the lens edge from the slot comprises engaging and moving outwardly a plurality of portions of the annular member to expand the opening, and removing the lens edge from the slot.

6. The method of claim 5, further comprising providing a tool with a plurality of fingers, wherein the annular member has two sides and at least one groove defined in one of the sides, and wherein the step of engaging the annular member comprises engaging the groove with the fingers of the tool.

7. An ophthalmic lens polished by the method of claim 1.

8. A method of manufacturing an ophthalmic lens, the method comprising:
a) forming the lens with at least one optic surface and at least one edge;
b) providing an annular member having an inner surface and a slot defined in the inner surface;
c) inserting the lens edge into the annular member slot but leaving the lens optic surface exposed;
d) inserting the lens into a container containing a fluid;
e) agitating the container, wherein the at least one lens optic surfaces are polished but the lens edge is not polished;
f) removing the lens from the container; and
g) removing the lens edge from the annular member slot.

9. The method of claim 8, wherein the step of inserting the lens edge into the slot comprises pressing the lens and the annular member together, and wherein the step of removing the lens edge from the slot comprises bending the annular member to expose a portion of the lens edge.

10. The method of claim 8, wherein the step of inserting the lens edge into the slot comprises engaging and moving outwardly a plurality of portions of the annular member, inserting the lens edge into the slot, and releasing the annular member; and wherein the step of removing the lens edge from the slot comprises engaging and moving outwardly a plurality of portions on the annular member to expand the opening, and removing the lens edge from the slot.

11. The method of claim 10, further comprising providing a tool with a plurality of fingers, wherein the annular member has two sides and at least one groove defined in one of the sides, and wherein the step of engaging the annular member comprises engaging the groove with the fingers of the tool.

12. The method of claim 8, further comprising mixing beads with the fluid in the container.

13. The method of claim 8, wherein the step of agitating the container comprises rotating the container.

14. The method of claim 13, further comprising providing one or more rollers, wherein the step of rotating the container includes positioning the container on the rollers and rotating the rollers.

15. An ophthalmic lens produced by the method of claim 8.

16. An article for protecting an edge of an ophthalmic lens during polishing, the lens having a diameter and at least one optic surface, the article comprising:
an annular member having an inner surface and a slot in the inner surface for receiving the lens edge, the inner surface defining an opening having a dimension that is smaller than the lens diameter and the slot having adimension that is at least equal to the lens diameter, whereby the lens can be inserted into the opening with the lens edge within the slot and the at least one lens optic surface exposed.

17. The article of claim 16, wherein the annular member has two sides and at least one groove defined in one of the sides.

18. The article of claim 16, wherein the annular member has an outer head portion that is adapted for grasping.

19. The article of claim 16, wherein the annular member is of a one-piece construction.

20. The article of claim 16, wherein the annular member comprises an elastic material.

21. An ophthalmic lens comprising at least one polished optical surface and an edge, wherein the edge is protected during polishing of the at least one optical surface to maintain the edge in an unpolished state.

22. The ophthalmic lens of claim 21, wherein the edge of the lens is generally square.

23. An edge protection ring for preventing an edge of a lens from being polished during polishing of at least one optical surface of the lens, the edge protection ring comprising an opening for receiving the edge of the lens and exposing the at least one optical surface of the lens.

24. The edge protection ring of claim 23, further comprising means for releasably engaging the edge of the lens.
